(19) United States
(12) Patent Application Publication
(10) Pub. No.: US 2014/0136437 A1
(43) Pub. Date: May 15, 2014

(54) METHOD FOR COMPILATION AND EVALUATION OF A CURRICULUM VITAE

(71) Applicant: Matteo ACHILLI, ROMA (IT)

(72) Inventor: Matteo ACHILLI, ROMA (IT)

(21) Appl. No.: 13/778,560

(22) Filed: Feb. 27, 2013

(30) Foreign Application Priority Data
Nov. 12, 2012 (IT) MI2012A 001919

(51) Int. Cl. G06Q 10/10

(52) U.S. Cl. CPC G06Q 10/1053
USPC 705/321

(57) ABSTRACT

A method to evaluate and classify curricula vitae includes the steps of inserting a plurality of data relating at least to the formation and/or professional experience of a plurality of candidates into storage, associating to the data entered a corresponding measuring parameter representative of the data and calculating a parameter of evaluation defined by above-mentioned measurement parameters.

### CROSS-REFERENCE TO RELATED APPLICATION

This claims the priority benefit of Italian Patent Application No. MI2012A 001919 filed on 12 Nov. 2012, incorporated herein by reference.

### FIELD OF THE INVENTION

The object of the following invention is a method to evaluate and classify curricula vitae.

### BACKGROUND OF THE INVENTION

There are known websites through which a candidate fills in a curriculum vitae representative of a personal, educational and occupational situation.

The compilation of the curriculum vitae consists of the insertion in the website of information relating to personal education and/or professional experiences.

By means of the website, the curriculum vitae is stored in a database and can be accessed to a variety of selectors in charge of looking for candidates for a particular vacant job position on behalf of corporations, companies or the like.

In addition, the candidate may send his/her own curriculum vitae to a selector working for a company or an entity considered interesting.

In order to facilitate the search for suitable candidates for the vacant job position, the selector is allowed to publish job advertisements to which applicants may respond by sending their curriculum vitae.

Through the use of the website, the selector picks out a number of curricula vitae among those received directly from candidates and/or those available in the database and analyzes them to track a group of suitable candidates.

The evaluation of curricula vitae is carried out by a researcher and/or qualified staff that compares the information with some reference parameters determined by the nature of the vacant job position.

The solution of the type mentioned above has various drawbacks related to a difficult, subjective and inaccurate evaluation of the information contained in the curriculum vitae of a candidate.

Furthermore, once analyzed the curricula vitae, even the comparison between them is complicated especially in the case of candidates with formation and work experience very similar or conversely very different. It is therefore difficult to establish a ranking that determines an order of preference for curricula vitae analyzed.

### SUMMARY OF THE INVENTION

The purpose of the present invention is to achieve a method for the evaluation and classification of the curricula vitae which is capable to solve the problems mentioned above. In particular, the purpose of the present invention is to provide a fast, accurate and objective evaluation method of the information contained in a curriculum vitae.

A further aim of the present invention is to provide a method for the evaluation and classification of curricula vitae that allows an easy and accurate comparison between the information contained in the curricula vitae of the candidates.

These and other objects which will be apparent to the expert of this particular field are attained by a method for the evaluation and classification of curricula vitae realized in according to the appended claims.

### BRIEF DESCRIPTION OF THE DRAWINGS

For a better understanding of the present invention are attached by way of example, but not limiting, the following drawings, in which:

FIG. 1 shows a flow chart that illustrates a method according to the present invention;

FIG. 2 is a diagrammatic representation of a main page of a web site displayed during different phases of the method in FIG. 1;

FIG. 3 shows a flow chart that focuses on a different aspect of the present invention.

### DESCRIPTION OF THE PREFERRED EMBODIMENTS

The reference number 1 indicates a flow chart that schematically shows a method for the evaluation and classification of the curricula vitae according to the present invention.

The method for the evaluation and classification of curricula vitae includes a stage to register a user, or rather a candidate who would like to compile a curriculum vitae. This phase consists in inserting a plurality of login information preferably in a website.

These login data afore-mentioned enable the identification of candidate and include, by way of example, at least the name, surname, e-mail address and password of the candidate. To complete the registration phase, the candidate must enter a control code, such as an alphanumeric one.

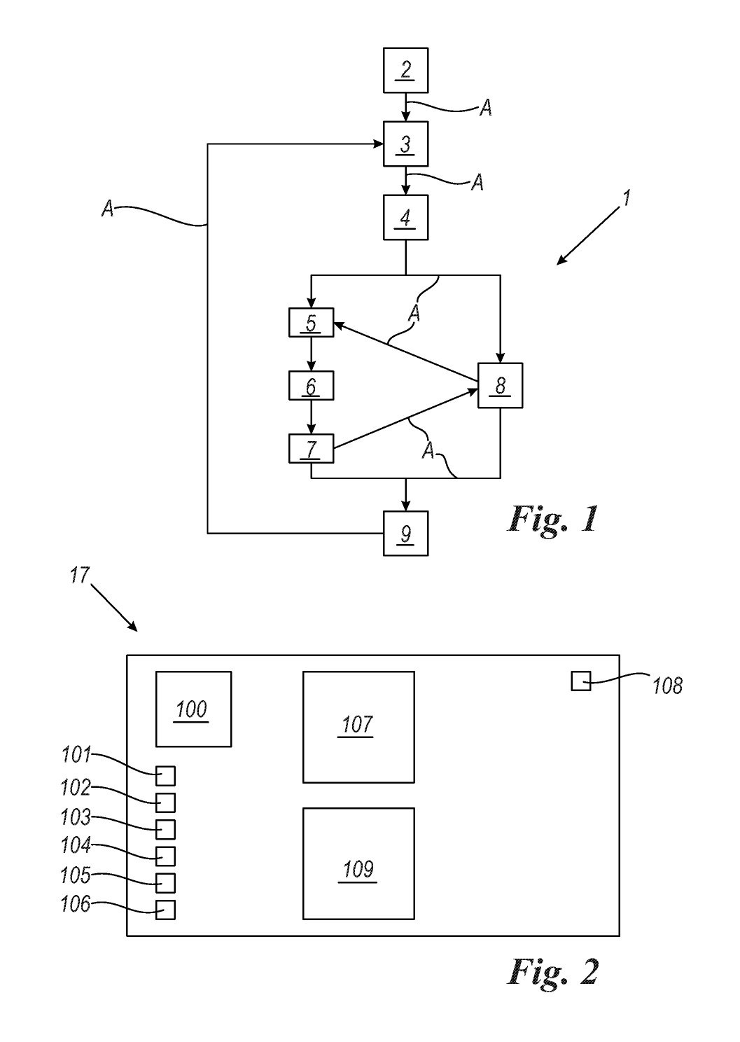

This registration phase is schematically represented by block 2 shown in FIG. 1.

After the registration phase follows a step of access that requires to enter the e-mail address and password inserted during the registration phase. This entry is required for each access to the website.

This phase is carried out through a corresponding access page and represented schematically by block 3 shown in FIG. 1.

Once logged in, the website displays a main page schematically designated by numerical reference 17 shown in FIG. 2.

After logging into the website, the candidate fills in its own profile with personal details. The compilation of the profile is achieved during a phase of insertion of personal details represented schematically by block 4 shown in FIG. 1.

For this purpose, the main page 17 displays a form that allows the candidate to enter personal details, such as, name, surname, date of birth, residence and domicile.

At the end of the inserting data process, these data are displayed in the main page 17, in a particular profile view 107.

The candidate may also improve their profile by entering a photograph or a generic image respectively shown in a display area of your photograph or image 100 (FIG. 2).

In an alternative way (not shown), the insertion phase of the personal details can be performed by means of an inclusion page to enter information (not represented in the figures), different from the main page 17.

During a subsequent access to the website, the applicant may modify and/or integrate the personal data previously entered by upgrading its own profile. These changes and/or additions are made by an edit icon displayed on the main page 17 of the candidate. The edit icon allows you to display again the compilation form. After the modification and/or the integration of the profile, the website displays the main page 17, which shows the data of the candidate.

Registration data and personal data are stored in the storage means connected to the website using a normal internet connection known to the expert of this particular field. The storage means are, for example, a server or any memory in which the candidate may be accessed through the internet.

For the purposes of the present invention, the candidate then performs a compilation phase of their curriculum vitae represented schematically by a block 5.

This compilation of the curriculum vitae consists in inserting a plurality of data relating to at least the formation and/or professional experience of the candidate.

To that end, the main page 17 displays an icon curriculum vitae 101 which allows the candidate to gain access to a corresponding compilation page of the curriculum vitae.

This compilation page of the curriculum vitae allows the insertion of the above-mentioned data relating to the candidate, for example typing such data through the use of a keyboard.

Conveniently, in an alternative way, in order to facilitate the insertion of the above mentioned data, the compilation page of the curriculum vitae can display so-called pull-down menu or the like in which is listed and ordered a plurality of predetermined options. These pull-down menu or the like allow for quick consultation and selection of preset options.

These preset options are examples of the data the candidate must choose, at least data inherent to the formation and/or professional experience in a generic candidate, facilitating and speeding up the completion of the curriculum vitae.

These preset options are stored in the storage means in order to make them available to the candidate.

Similarly to the personal details, the data entered during the compilation of the curriculum vitae are stored in the storage means and associated with the personal details and with those of the registration of the candidate.

In detail, the data that the candidate may enter are the diploma and/or degree achieved, also indicating the final grades obtained. The data can also be related, in case the candidate has not yet completed the degree course, to the vote and the credits for every single exam already taken.

After this operation the above mentioned storage media or a computer connected to these means of storage, calculate a weighted average of the votes of examinations taken.

In order to facilitate the insertion of data regarding, for example, the degree obtained, the page curriculum vitae displays some elements, preferably in the order indicated below:
a map that shows the Italian regions and among which the candidate selects the region in which is situated the university he attended;
a list of universities having their registered in the selected region, among which the candidate selects the university attended;
a list of selected university faculty among wick the candidate selects the faculty attended;
a list of graduate courses taken at the faculty selected, among which the candidate selects the course attended;
a list of types of degree (eg bachelor degree, master degree) relative to the course selected, among which the candidate selects the type of degree course attended.

In addition, the preset options selected by the candidate include data for postgraduate diplomas, PhD, informatic certifications and language certificates, apprenticeships, internships, publications, previous work experience, study abroad, languages spoken, and more.

In order to best describe his own person, the candidate may enter additional data about hobbies and traits of his/her personality.

The candidate may also indicate if is looking for a job or an internship or apprenticeship.

At the end of the compilation phase of the curriculum vitae, the data about the formation and/or professional experience and those data concerning hobbies and personality traits of the candidate are stored in the storage means.

These data, like personal details, are displayed on the main page 17 in a corresponding viewing area of the curriculum vitae profile 109.

For the purposes of privacy, the candidate may choose which data display and make available to the public in its own home page and which make invisible.

Advantageously, after the compilation of the curriculum vitae starts a step of measuring the input data about the formation and/or professional experience, represented schematically by block 6 shown in FIG. 1.

The evaluation of the inserted data consists in associating such data included with a corresponding measurement parameter representative of each of such data.

The measurement parameters are, for example, numerical values that allow to associate to each data inserted a relevance or importance proportional to the numerical value of the associated data, thus enabling to measure in an objective and accurate way data each inserted.

This measurement phase is performed by a computer appropriately connected to the storage means.

Using the alternative way of compilation in which the candidate selects data from drop-down menu or the like, a preliminary stage is performed consisting in assign to each option its own predetermined numerical value. These preset options and related numerical values associated with them are saved, for example, in the tables stored in the storage means, making the preset options and their numerical values available for the measurement phase.

Advantageously, when the candidate selects a predetermined option is automatically selected the corresponding numeric value.

The measurement parameters are constant numerical values and/or variable numerical values.

The constant numerical values are predetermined and steady numbers because they are defined on the basis of the different importance or significance proper to a specific data.

By way of example, the constant numerical values may be associated with the data relating to the achievement of postgraduate diplomas, PhD and certifications.

In order to make more clear how the constant numerical values allow for the measurement and classification of data, take for example the informatic certification Eipass, ECDL Core and ECDL Advanced. Given That ECDL Advanced certification is considered objectively more important and/or prestigious than the ECDL Core certification and being the ECDL Core certification considered objectively more important and/or prestigious of the Eipass, measuring parameters conferred upon such data are, for example, 12 for Advanced ECDL, ECDL Core for 10 and 8 for Eipass.

It is therefore clear that these numerical values are used to define objectively a rank of the importance and relevance of the data entered.

The numerical variable values are associated with data such as, for example, work experience, internships, the internship and apprenticeships.

The variable numerical value is a number that changes its value depending on the type of data entered.

Considering for example, the variable numerical parameter related to the degree, the number varies according to the degree mark, the years to achieve the same degree and the prestige of the university where the candidate has undertaken the degree selected.

Differently, in the case of data on internships, apprenticeship and work experience, the variable numerical parameter changes depending on, for example, the duration of the employment relationship, the number of employees and turnover of the company with which the candidate established the employment relationship.

The calculation of the variable numerical value therefore allows the definition of accurate and objective measurement parameters.

In detail, the evaluation parameter is calculated by performing the arithmetic sum of the measurement parameters for data that belongs to the curriculum vitae of the candidate.

Alternatively, the evaluation parameter can be calculated using any other method of calculation, for example an average of the numerical values associated with these measurement parameters.

At the end of the calculation phase, the evaluation parameter is stored in the storage means, making the evaluation parameter accessible to other registered users of the website, such as additional candidates and/or selectors in charge of research on behalf of companies and/or institutions, of candidates for a particular job position.

When the candidate, for subsequent access to the website, edit the data concerning the formation and/or professional experience, the computer re-execute the measurement phase and the calculation phase updating the parameter.

The calculation phase is schematically represented by block 7 place after block 6, as shown in FIG. 1.

Advantageously, the evaluation parameter mentioned above allows selectors to assess in an immediate, accurate and objective way the curriculum vitae of the candidate in question.

The classification is performed by ordering the evaluation parameters according to the corresponding numeric value, for example in an increasing or decreasing order.

This classification allows the selector for an immediate and objective comparison of the curricula vitae of the candidates.

Advantageously, the candidate can view a list in which appear the names of the registered candidates on the website and their corresponding evaluation parameters, also showing the position in the list.

This list is displayed in a respective page rank to which the candidate may access through a ranking icon 102 displayed on the main page 17.

Alternatively, the candidate can display a list comprising, for example, the parameters of evaluation of all candidates registered to the website or the candidates from the same university or enrolled in the same degree course or regarding the region of residence of the candidate.

The candidate can also communicate with other users registered on the website by sending and receiving text messages. For this purpose, the main page 17 shows an icon contacts 103 through which the candidate displays a corresponding contact page that allows to search and view profiles and data about candidates registered to the website.

The candidate may also select a number of users registered on the website, achieving in this way a list of candidates of interest. This list thus allows a quick view of the profiles of the candidates listed in that list, reducing the time required to search the profile of a candidate and sending a text message to that candidate.

As described for the contact page, the candidate can view profiles, for example, companies or organizations registered on the website.

To this end, the main company 17 has an icon 104 by which the candidate displays a corresponding company page which lists the names of the companies or organizations registered on the website.

Through the company page, the candidate leads to a page of such companies or entities, displaying the profile and possible jobs and/or messages published, for example, about such jobs (as will be described below). The applicant, through this page, can deploy an application to a company or an organization of interest. For this purpose, the main page 17 displays an icon ads 105 which allows the candidate to search for jobs, for example through a search engine that allows you to search for keywords. To this end, the candidate displays a page where are displayed advertisements and lists all the jobs posted by companies or organizations registered on the website.

The phases described above are represented schematically by a single block 7. This block 7 is then a plurality of steps that can be executed before or after the phases schematically represented by the blocks 5 and 6.

The phases schematically represented by block 8 can be performed in any chronological order.

Finished the phases of measurement and calculation, or the phases schematically represented by block 8, the candidate may disconnect from the website, or carries out once more the steps summarized from blocks 5, 6, 7 and 8 aforesaid.

The disconnection is performed during a disconnection phase represented schematically by block 9.

Disconnection is carried out by a disconnection icon 106 shown on the main page 17.

When the candidate logs out the website displays the login page.

The chronological order of execution of the phases schematically represented by the blocks 2, 4, 5, 6, 7, 8 and 9 shown in FIG. 1 is specified by the direction of arrows A, also shown in FIG. 1.

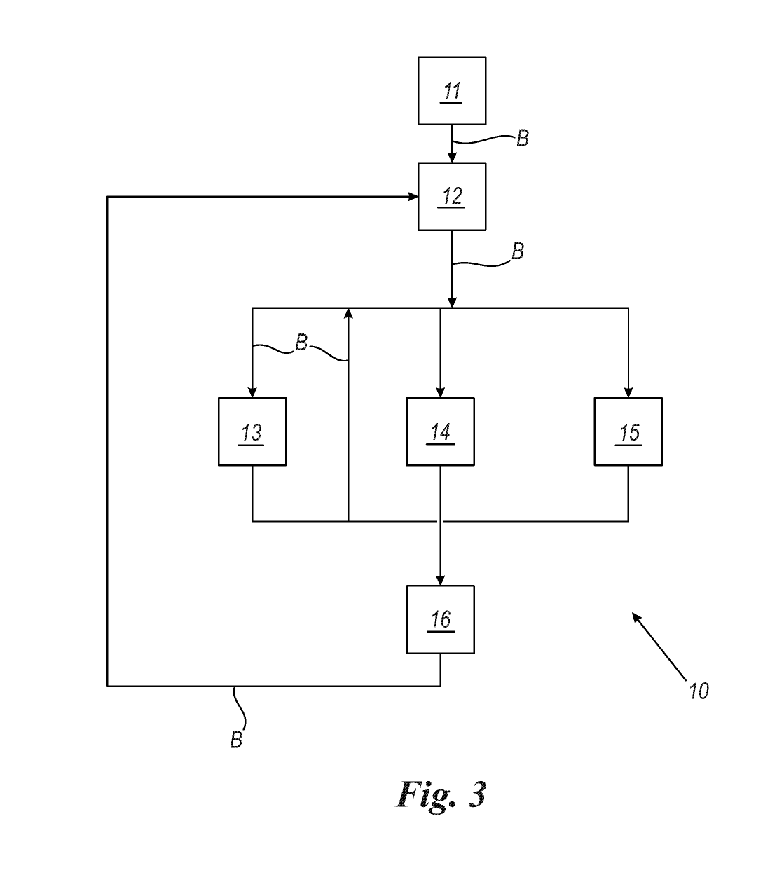

With reference to FIG. 3, a diagram 10 shows schematically the steps performed by a selector looking for a candidate for a particular vacant job position.

These steps can be performed simultaneously with stages represented schematically by the method shown in FIG. 1.

The selector is a worker that uses the website as representative, for example, of a company or an organization. The selector faces the task of seeking suitable candidates to fill specific vacant job positions.

The selector, like a candidate, to use the functions provided by the website needs to register, for example, through a registration page.

To do this, the selector enters data such as the name, company name, the location, VAT number, category and a logo representative of the company, also entering name, last name, e-mail address and a password.

This registration is performed during a candidate registration phase on the website.

The registration process is schematically represented by block 11 shown in the diagram 10 of FIG. 3.

The above mentioned data are stored in the storage means.

Whenever the selector accesses the website must enter the e-mail address and password provided during the registration phase. This access is performed by the selector during an access phase represented schematically by a block 12 indicated above.

Unlike the procedure offered to the user, selector's account is activated at the discretion of the administrators of the website.

Whenever the selector accesses the website a specific main page selector is displayed.

The structure of the selector's main page is very similar to the main page of the candidate shown in FIG. 2.

The selector's main page displays a plurality of icons that allows the candidate to access and use the various features of the website.

The main selector page has, for example, a profile icon, a message icon and a company's icon with similar functionality to the corresponding icons displayed on the main page of the candidate.

The profile icon allows the selector to produce a compilation of the profile, for example, means of a respective profile page. In this regard, the page selector enters data about the company or organization he represents, drafting this way the company profile.

The messages icon allows the selector to communicate with other candidates, companies or entities registered to the website, for example, by sending and receiving text messages. Writing and reading of text messages are performed, for example, by means of a page messages.

The company icon allows the selector to achieve a research phase of registered company's website, for example by means of a page society.

The steps of compiling the profile, sending and receiving messages and research are schematically represented by a single block 13 shown in FIG. 3.

Differently from candidate, the selector in his own main page shows a list or a ranking that displays the names of candidates whose curriculum vitae has the greater evaluation parameter, for example with respect to all candidates registered to the website.

In addition, the selector can search among the curricula vitae of the registered candidates.

To achieve this aim the selector benefits from a search engine that allows to search among the curricula vitae of the candidates. In order to optimize this search the selector can use keywords selected from preset options or can use ranges of numerical values associated with the parameters of evaluation.

The selector can use the search engine through a candidates search page displayed by a candidate's search icon present on the main page of the selector.

This search is performed during a corresponding candidates search phase represented schematically by a block 14 shown in FIG. 3.

The names of the candidates obtained through the research are supplied following a descending order of evaluation parameters. In this way, the search results may be checked quickly and effectively by the selector.

These names identified by the research are saved in a list displayed in a corresponding interests page. This list then allows to collect and display the names of candidates sought and considered suitable to fill the vacant job position and therefore suitable to a subsequent in-depth personal interview.

As mentioned above, before and/or after performing the candidate's research phase, the selector may write and publish job advertisements to search for one or more candidates for a particular vacant job position. The selector can also view and/or edit and/or delete the advertisements previously published and view applications received on these ads.

The selector can also create and publish on the main page of the company or organization he represents, text messages for example, about the new job positions sought.

As mentioned above, candidates can view and answer these text messages. The creation and publication of job advertisements and text messages relating to them are performed during a phase of creation and publication represented schematically by a block 15.

The phases described above and schematically represented by the blocks 13, 14 and 15 may be performed, among them, in any chronological order.

Subsequently to the phases represented by the above mentioned blocks 13, 14 and 15, the selector can rerun one or more of the above actions or can disconnect from the website.

The disconnection is performed, for example, by means of a disconnection icon shown on the main page of the second user of FIG. 3.

The disconnection from the website is performed during a disconnection phase represented schematically in FIG. 3 by block 16.

After the disconnection phase the website displays the login page.

The chronological order of execution of the phases schematically represented by the blocks 11, 12, 13, 14, 15, 16 shown in FIG. 3 is indicated by the direction of arrows B, also shown in FIG. 3.

Advantageously, according to a further embodiment of the present invention, the registration to the website can be performed from an internet page external and different from the website object of the present invention. The candidate may register to the website using an online application form that appears, for example, in the Internet page of companies or public entities such as provinces, regions and more.

In this case, after entering the registration data in the form of compilation, the candidate is directed to the main page of the candidate, this main page of the candidate is inside the website object of the present invention.

In this way the number of candidates registered on the website object of the present invention has increased, allowing the selector to perform a search among a larger number of curriculum vitae and potential candidates for a job position vacant.

Advantageously, the companies or institutions that display on its website the above registration form are able to monitor through the website of the present invention, the candidates who register through the web page of such companies or organizations.

According to different scope of the present invention, the method in accordance with the present invention can be, at least in part, applied by a company or by an organization in order to assess and classify, in an objective and immediate way, skills, for example, of its employees.

In particular, such companies or institutions, may apply the phases 2, 3, 4, 5, 6, 7, 9 of the method shown in FIG. 1, assessing and classifying in an immediate and objective data inherent, for example, to an employee or a freelancer working within the company or entity. In this way it is therefore possible to define a method based on meritocracy, for example for the conferment of bonus regarding the productivity or still others.

On the basis of what has been described, it is therefore possible to realize a website and/or a software suitable for performing at least in part the method for the evaluation and classification of curricula vitae object of the present invention.

The invention thus described achieves the proposed aim because it provides a method for the evaluation and classification of curricula vitae that, through the association of a measurement parameter for any data present within that curriculum vitae, allows the calculation of an assessment parameter a plurality of curricula vitae.

These evaluation parameters allow the comparison and classification of curriculum—vitae of various candidates.

1. A method for evaluating and classifying curricula vitae comprising the following steps:
inserting a plurality of data relating to at least the education and/or the professional experiences of a plurality of candidates in storage means,
associating to said inserted data a corresponding measurement parameter representative of said data,
calculating an evaluation parameter defined by said measurement parameters.

2. The method according to claim 1, wherein said measurement parameters are constant numeric values and/or are numeric values variable according to the corresponding inserted data.

3. The method according to claim 1, wherein said evaluation parameter is obtained calculating the sum of said measurement parameters.

4. The method according to claim 2, wherein said variable numeric values depend upon a degree mark and/or the years taken to take said degree and/or the duration of an employment relationship and/or the number of the employees relating to a company in which said employment relationship occurred and/or said company turnover and/or said company employees number.

5. The method according to anyone of the preceding claims, wherein said step of inserting said data comprises the steps of selecting said data among a plurality of predetermined options.

6. The method according to claim 1, comprising the step of arranging said candidates in order according to the evaluation parameter.

7. The method according to claim 1, wherein said evaluation parameters and/or said measure parameters are stored in said storage means.

8. A web site suitable to carry out the method according to claim 1.

9. A software suitable to carry out the method according claim 1.
